(19) United States
(12) Patent Application Publication
(10) Pub. No.: US 2021/0110626 A1
(43) Pub. Date: Apr. 15, 2021

(54) SECURITY SYSTEM

(71) Applicant: Intel Corporation, Santa Clara, CA (US)

(72) Inventors: Sebastian Mariano Salomon, North Plains, OR (US); Cesar I. Martinez-Spessot, Hillsboro, OR (US); Marcos E. Carranza, Portland, OR (US)

(21) Appl. No.: 16/464,410

(22) PCT Filed: Dec. 29, 2016
(86) PCT No.: PCT/US2016/069131

§ 371 Date: May 28, 2019

(51) Int. Cl. G07C 9/32; G07C 9/00

(52) U.S. Cl. CPC G07C 9/32; G07C 2209/14; G07C 9/00896

(57) ABSTRACT

A monitoring system includes a sensor to detect a behavioral pattern of a person entering the defined space, a storage to store a behavioral pattern and a personal characteristic of the person, a pattern comparison logic to compare the detected behavioral pattern with the behavioral pattern, and determine that access to the defined space is allowed if at least the detected behavioral pattern matches the behavioral pattern stored in the storage, or is not allowed if the detected behavioral pattern does not match the behavioral pattern. Logic is configured to generate a signal indicating that access to the space is allowed if the pattern comparison logic determined that access to the defined space is allowed, and generate a signal triggering an alarm if the pattern comparison logic determined that access to the defined space is not allowed.

### FIELD

The subject matter disclosed herein relates generally to a system and techniques to control an access to a defined space such as a private house or an office.

### RELATED ART

Current security systems such as home security systems require a physical device, pin or biometric key to arm or disarm the security system by a user if the user wants to enter his or her house or secure it, respectively. In conventional systems the user can be a point of weakness regarding security of access. For example, a password or pin is frequently noted down somewhere by users in order to recover the password or pin if the user cannot remember it. If unauthorized users get hold of the noted down password or pin an unauthorized access to the house becomes very easy. In other cases, security systems are not used or activated since they are cumbersome to use. The subject matter disclosed herein aims to overcome these shortcomings.

### BRIEF DESCRIPTION OF THE DRAWINGS

FIG. 1 shows a schematic representation of an apparatus according to an aspect of the present disclosure;

FIG. 2 shows a sketch of a house and an example path of a user between different locations in the house;

FIG. 3 shows an example of a method for controlling access to a defined space;

FIG. 4 shows another example of a method for controlling access to a defined space;

FIG. 5 shows a further example of a method for controlling access to a defined space; and

FIG. 6 shows yet another example of a method for controlling access to a defined space;

### DETAILED DESCRIPTION

Reference throughout this specification to “one aspect of the present disclosure” or “an aspect of the present disclosure” means that a particular feature, structure, or characteristic described in connection with the aspect of the present disclosure is included in at least one aspect of the present disclosure. Thus, the appearances of the phrase “in one aspect of present disclosure” or “in an aspect of the present disclosure” in various places throughout this specification are not necessarily all referring to the same aspect of the present disclosure. Furthermore, the particular features, structures, or characteristics may be combined in one or more aspects of the present disclosure.

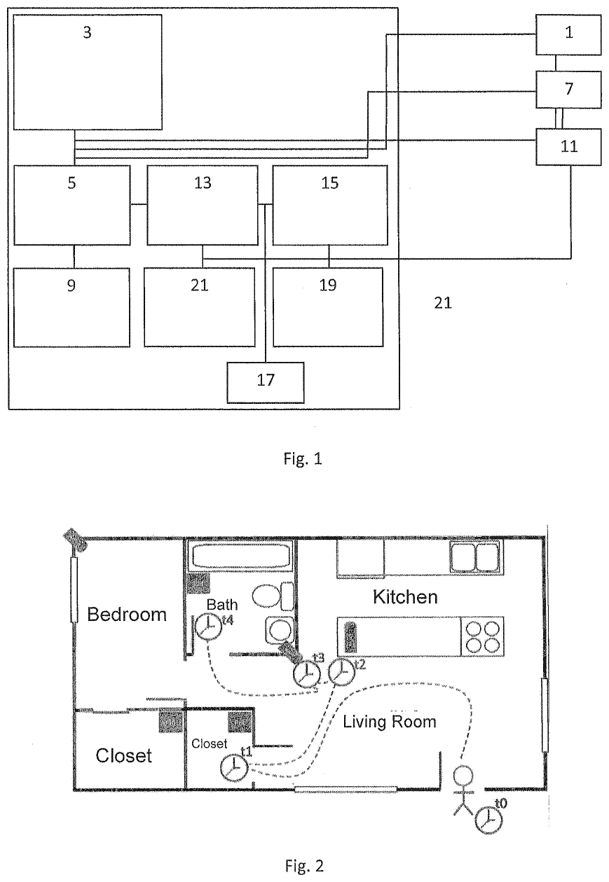

Various aspects of the present disclosure as described with reference to the figures provide a system and techniques to control an access to a defined space. An example of a monitoring system is described in FIG. 1. According to an aspect of the present disclosure, a monitoring system for monitoring access of a person to a defined space comprises at least one sensor 1 configured to detect a behavioral pattern of a person entering the defined space, a storage 3 configured to store at least one behavioral pattern and optionally, in addition, at least one personal characteristic of the person, and a pattern comparison logic 5 configured to compare the detected behavioral pattern with the behavioral pattern stored in the storage and determine that the access of the person to the defined space is allowed if at least the detected behavioral pattern matches the behavioral pattern stored in the storage as a result of the comparison or is not allowed if the detected behavioral pattern does not match the behavioral pattern stored in the storage as a result of the comparison. The system can have several sensors for detecting behavioral patterns of the person. The sensor can be a camera, an IR sensor, a PIR sensor, a touch pad, a mouse, or a keyboard or any other suitable sensor. The sensors can be distributed throughout the defined space as appropriate. The storage 3 can include several behavioral patterns and optionally also several personal characteristics of a person which can be stored in the storage before a determination of an authorization of an access is made.

A behavior pattern is more difficult to be stolen and is easy to remember for the user. Hence, it can be used as a secure code of access to a defined space. Usually people have a behavioral pattern to get into and leave a house. For example in a workday a person may always follow the same pattern of activities when returning home. For example, the person most of the days enters the house at the same time, uses the same door to get into the house and deposits the bag at the same place in the house etc. One or more sensors or cameras installed in the house can monitor this pattern of behavior of the person and use the pattern for an authorization for a user to enter into a defined space and/or as an authorization to disarm the alarm system of the house.

According to another aspect of the present disclosure, the system comprises at least one further sensor 7 configured to detect a personal characteristic of the person. The at least one sensor 1 configured to detect a personal characteristic of the person is one of a camera, a RF receiver, an IR sensor, a PIR sensor, a touch pad, a fingerprint sensor, a mouse, a keyboard, and a biometric sensor. The personal characteristic can be one of a physical feature of the person, a feature of a device belonging to the person such as a mobile phone, a watch or a computer, a backpack, a hat, and a time when an act or a behavioral pattern is performed by the person. A physical feature can be for example a fingerprint, a face, a color of hair or skin of the person, the height of a person, gender etc. The system can have several sensors for detecting one or more personal characteristics of the person. A personal characteristic of a person as detected by one or more sensors can be used in combination with a pattern of behavior as an authorization for a user to access a house or to disarm an alarm system.

According to another aspect of the present disclosure, the system may comprise a personal characteristic comparison logic 9. The personal characteristic comparison logic is configured to compare the detected personal characteristic with the personal characteristic stored in the storage 3, and determine that the access of the person to the defined space is allowed if at least the detected personal characteristic matches the personal characteristic stored in the storage 3 as a result of the comparison or is not allowed if the detected personal characteristic does not match the personal characteristic stored in the storage 3 as a result of the comparison. The comparison logic 9 is coupled at least with the sensor 1 for detecting a behavioral pattern of a person to receive a detected signal and the storage 3 for retrieving one or more behavioral pattern(s) stored therein. I may also be coupled with other components of the system. The behavioral pattern of the person can include a sequence of one or more acts performed by the person such as entering a location in the defined space, opening of a door of a room or a window in the defined space, entering a room in the defined space, actuating one of a switch, a light switch, a water tap, a remote control, an on-off switch of an household appliance, or an consumer electronics device. These acts can be detected with corresponding sensors. Other acts performed by the person as part of a behavioral pattern are possible as well.

According to yet another aspect of the present disclosure, the pattern comparison logic 5 determines that the detected behavioral pattern matches the behavioral pattern stored in the storage 3 as a result of a comparison, when the sequence of acts of the detected behavioral pattern at least partly corresponds to the sequence of acts of the at least one behavioral pattern stored in the storage 3.

The sequence of acts of the detected behavioral pattern can at least partly correspond to the sequence of acts of the at least one behavioral pattern stored in the storage 3 when both sequences of acts include a same sequence of two or more subsequent acts. Accordingly, a behavioral pattern can be defined as a number or sequence of acts performed by a person. The number of acts included in a behavioral pattern is at least two, but may also be more than two like such as, for example, 5 or 10 acts or even hundreds of acts. However, other criteria for determining that a detected behavioral pattern corresponds to a sequence of acts of at least one behavioral pattern stored in the storage 3 can be defined as well. For example, a correspondence between stored and detected behavioral pattern may be determined as existing if one or more sequences of more than two acts, for example, 5 or 10 or more acts in a sequence of acts of a detected behavioral pattern corresponds to a stored sequence of acts of at least one behavioral pattern.

According to another aspect of the present disclosure, the system further comprises a time detection means 11 for detecting a time when at least one of the acts included in the behavioral pattern is performed or the personal characteristic is detected. Optionally the system may comprise a time comparison logic 13 that is configured to compare at least one of the time when at least one of the acts included in the behavioral pattern is detected with a time stored in the storage 3 that is related to the stored at least one of the acts included in the behavioral pattern of the person, and the time when the personal characteristic is detected with at least one time stored in the storage 3 that is related to the stored at least one personal characteristic. The time detection means 11 may be coupled to all or some of the time comparison logic 13, the sensor 1 for detecting a behavioral pattern or the sensor 7 for detecting a personal characteristic. The time detection means 11 may also be integrated into one or both of the sensor 1 for detecting a behavioral pattern or the sensor 7 for detecting a personal characteristic. The time detection means 11 may be coupled to the storage 3 to store times detected.

According to another aspect of the present disclosure, the time comparison logic 13 is further configured to determine that the access of the person to the defined space is allowed if the time when at least one of the acts included in the behavioral pattern is detected matches the time stored in the storage 3 that is related to the at least one act included in the at least one behavioral pattern of the person stored in the storage 3 or is not allowed if the time when the behavioral pattern is detected does not match the time stored in the storage 3 that is related to the at least one act included in the at least one behavioral pattern of the person stored in the storage 3 as a result of the comparison. Optionally, the time comparison logic 13 is further configured to determine that the access of the person to the defined space is allowed if the time when the personal characteristic is detected matches the time stored in the storage 3 that is related to the at least one personal characteristic of the person stored in the storage 3 or is not allowed if the time when the personal characteristic is detected does not match the time stored in the storage 3 that is related to the at least one personal characteristic of the person stored in the storage 3 as a result of the comparison. The time comparison logic 13 is coupled at least with the time comparison logic 13 and with the storage to receive detected times and stored times, respectively. Furthermore, the time comparison logic 13 is also able to store detected times as references for further comparisons.

According to another aspect of the present disclosure, the time comparison logic 13 is configured to determine that the time when at least one of the acts included in the behavioral pattern is detected matches the time stored in the storage 3 that is related to the at least one act included in the at least one behavioral pattern of the person stored in the storage 3, when both times are separated by a time interval of less than 10, 2, 1 hours, 60 minutes, 30 minutes, 10 minutes, 5 minutes, 1 minute, 30 seconds, 10 seconds, 1 second or less. Hence, the time comparison logic 13 is able to consider variations between the times when a user performs acts of a behavioral pattern and stored acts and also between the time of detection of a personal characteristic and the stored time of a personal characteristic.

According to another aspect of the present disclosure, the system further comprises a combination logic 15 that is configured to receive the results of the determinations that the access of the person to the defined space is allowed or not from one or more of the pattern comparison logic 5, the personal characteristic comparison logic 9, and the time comparison logic 13 and determines that the access of the person to the defined space is allowed if at least one of the pattern comparison logic 5, the personal characteristic comparison logic 9, and the time comparison logic 13 has determined that the access of the person to the defined space is allowed, and/or determines that the access of the person to the defined space is not allowed if at least one of the pattern comparison logic 5, the personal characteristic comparison logic 9, and the time comparison logic 13 has determined that the access of the person to the defined space is not allowed. Other criteria for deciding when the access of the person to the defined space is allowed or is not allowed can be applied by the combination logic 15 as well. For example, the combination logic 15 may determine that the access of the person to the defined space is allowed only if at least the pattern comparison logic 5, and at least one of the personal characteristic comparison logic 9, and the time comparison logic 13 has determined that the access of the person to the defined space is allowed. Another option would be that the pattern comparison logic 5, the personal characteristic comparison logic 9, and the time comparison logic 13 have determined that the access of the person to the defined space is allowed. Other decision criteria can be used as well. The decision criteria can be set be the user. The combination logic 15 is connected at least with the pattern comparison logic 5, the personal characteristic comparison logic 9, and the time comparison logic 13, but may also be connected to other components of the system as well.

According to another aspect of the present disclosure, the combination logic 15 is configured to weight the results of the determinations that the access of the person to the defined space is allowed or not as received from one or more of the pattern comparison logic 5, the personal characteristic comparison logic 9, and the time comparison logic 13 and to include the weights in the combination result so that the result of a determination that the access of the person to the defined space is allowed received from one of the pattern comparison logic 5, the personal characteristic comparison logic 9, or the time comparison logic 13 may have more or less weight on the decision of the combination logic 15 than the result received from one or more of the other logic units.

According to another aspect of the present disclosure, the system further comprises a transmitter 17 that is configured to transmit a signal including the result of the determination whether the access of the person to the defined space is allowed or is not allowed from the combination logic 15 or from one of the other logic units to a corresponding receiver for processing the signal. The receiver may for example trigger an alarm or disarm a security system if the user is authorized.

Furthermore, a logic 19 is provided that is configured to generate a signal indicating that the access to the defined space by the person is allowed if the pattern comparison logic 5 determined that the access of the person to the defined space is allowed and to generate a signal triggering an alarm if the pattern comparison logic 5 determined that the access of the person to the defined space is not allowed.

According to yet another aspect of the present disclosure, the system comprises a machine learning logic 21 configured to learn at least one of one or more behavioral patterns and one or more characteristics of a person. The machine learning logic may include a machine learning algorithm. The machine learning logic may receive pattern detection results from one or more of the pattern comparison logic 5, the personal characteristic comparison logic 9, and the time comparison logic 13 and use these results for a learning algorithm. The machine learning logic may be configured to train a security system such as a smart home gateway to accurately identify a person and to decide if that person is expected or authorized to enter a house and/or arm or disarm an alarm system. According to another aspect of the present disclosure, the defined space is an apartment, a house, an office, or a plant or another defined space.

FIG. 2 shows an example of an application of the monitoring system for entering a house. The dotted line in the figure represents an example path a person usually takes when he or she returns home. At the time t0 the person arrives at the house, and is detected by the smart home system installed since his or her handheld device (a mobile phone, a watch, notebook, etc.) is paired with the smart home system using e.g. a Bluetooth connection with a sensor that is installed at the door. A few seconds later the person enters the house and goes to the closet for depositing his or her backpack. This happens at the time t1 which is detected by a time detection means which is coupled with a motion sensor (PIR sensor) which detects the entering of the closet as one of the acts of the behavioral pattern performed by the person. After depositing the backpack the person as a habit uses to listen to a preferred playlist by using a voice recognition device. The voice recognition and the corresponding time are detected by another sensor in the house and time detection means at t2. After that the person looks into the camera for a second and a corresponding picture of his or her face is taken as a personal characteristic at the time t3 registered by a time detection means. Alternatively, the camera may detect and record a gesture as another act of a behavioral pattern. Finally, at t5 the person enters a bathroom to wash her hands which is detected by another PIR sensor. The detected acts and can be considered as a behavioral pattern which is compared together with the detected times and one or more personal characteristics of the person with one or more correspondingly stored behavioral patterns, personal characteristics and times to determine whether the person is authorized to enter the house. As a result of the determination, for example, an alarm system can be disarmed.

This aspect can also be extended to other systems going beyond security systems. For example, a situation may be considered when a family is at home at dinner. Then, a device could start playing a piece of music according to the specific behavioral pattern and time(s) detected as performed by the members of the family.

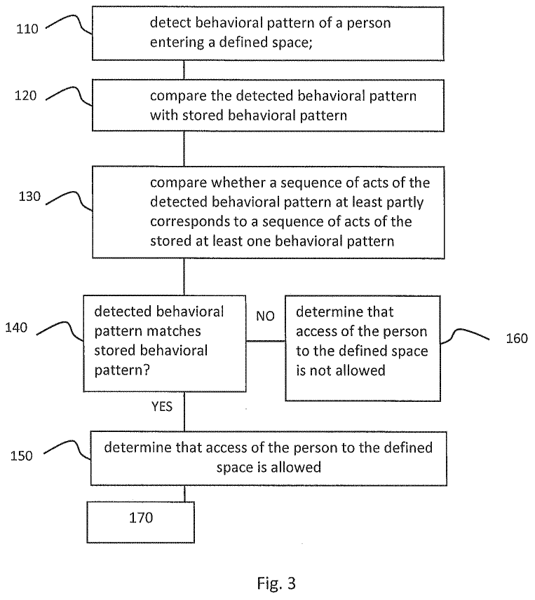

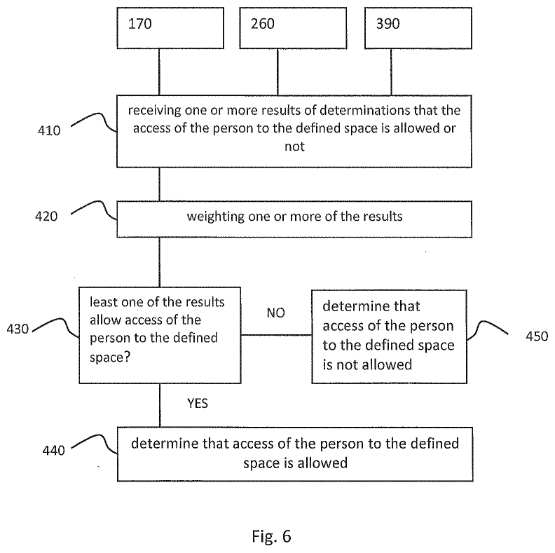

According to one aspect an example method of monitoring access of a person to a defined space is shown in FIG. 3. The method can be performed in a system like the system shown in FIG. 1. At block 110 a behavioral pattern of a person entering the defined space is detected by one or more sensors or cameras. The behavioral pattern of the person may include a sequence of one or more acts performed by the person including entering a location in the defined space such as opening of a door of a room or a window in the defined space, entering a room in the defined space, actuating one of a switch, a light switch, a water tap, a remote control, an on-off switch of an household appliance, or an consumer electronics device etc. At least one behavioral pattern and possibly also at least one personal characteristic of the person have been stored previously in a storage which can be used for a comparison with the detected behavioral pattern. At block 120 the detected behavioral pattern is compared with the at least one behavioral pattern stored in the storage in a comparison logic. Then, at block 140 as a result of the comparison, it is determined that the access of the person to the defined space is allowed (at block 160) if at least the detected behavioral pattern matches the behavioral pattern stored in the storage or is not allowed (150) if the detected behavioral pattern does not match the behavioral pattern stored in the storage. It may be determined that the detected behavioral pattern matches the behavioral pattern stored in the storage as a result of a comparison, when the sequence of acts of the detected behavioral pattern at least partly corresponds to the sequence of acts of the at least one behavioral pattern stored in the storage. More in detail, a sequence of acts of the detected behavioral pattern can be defined to at least partly correspond to the sequence of acts of the at least one behavioral pattern stored in the storage when both sequences of acts include a same sequence of two or more subsequent acts, such as 2, 3, 4, 5, 10, 20 or more corresponding acts. The corresponding sequences of the detected and stored behavioral patterns, respectively, may also comprise a number of corresponding acts which are not subsequent in the sequences, i.e. in one or both of the sequence which are compared an act in a detected sequence which corresponds to an act in a stored sequence may be followed by one or two acts which have no corresponding acts in stored sequence, but the sequence then includes a further act which has a corresponding act in the stored sequence. The result of the determination may be used in another method according to another aspect of the present application at 170 that is described with respect to FIG. 6.

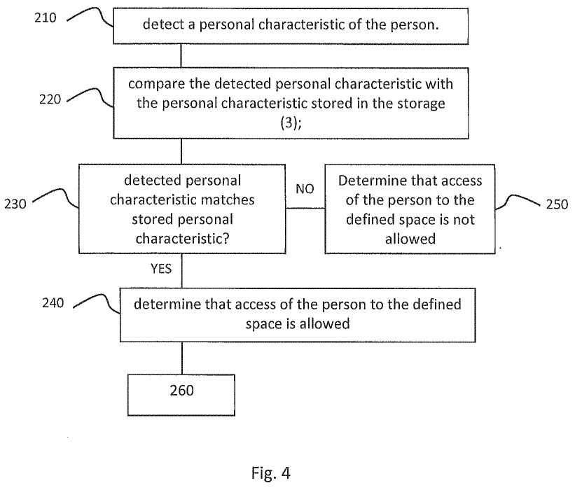

According to another aspect an example method of monitoring access of a person to a defined space may include one or several acts shown in FIG. 4. In block 210 one or more personal characteristics of the person are detected. A personal characteristic is a physical feature of the person such as for example, a fingerprint, the color of skin, the height, the color of hair, structure of the retina, the face, a feature of a device belonging to the person, such as for example, the ID of a computer a mobile phone, a bag, a watch etc., a time when an act or a behavioral pattern is performed by the person. At block 220 the detected personal characteristic is compared with the personal characteristic stored in the storage. It is determined at block 240 that the access of the person to the defined space is allowed if at least the detected personal characteristic matches the personal characteristic stored in the storage as a result of the comparison (block 230) or is not allowed at block 250 if the detected personal characteristic does not match the personal characteristic stored in the storage as a result of the comparison. The result may be used in another method according to another aspect of the present application at 260 that is described with respect to FIG. 6. The foregoing method may also be used in combination with one or more of the other methods in this disclosure.

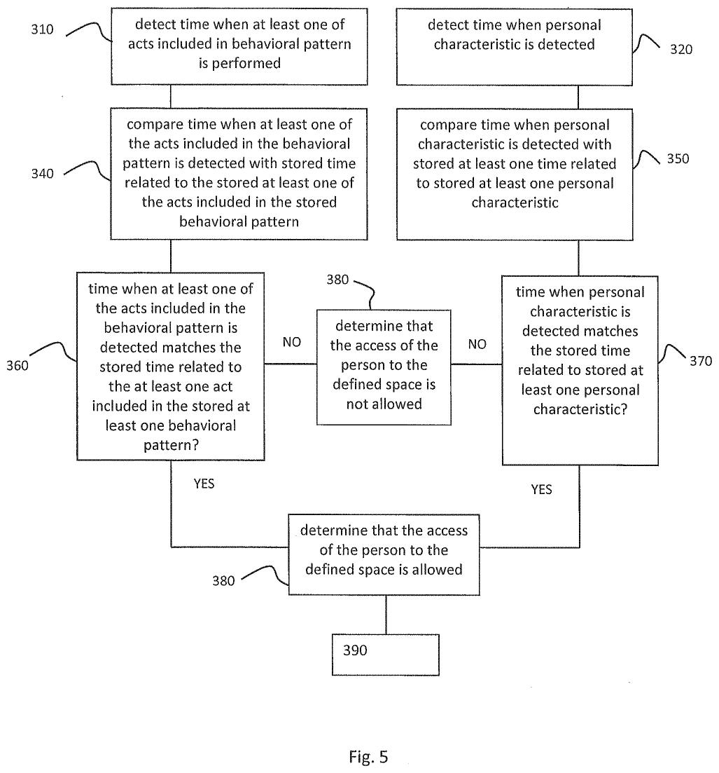

Another method according to another aspect of the application is shown in and described with regard to FIG. 5. The method includes, in a first path detecting a time when at least one of the acts included in the behavioral pattern is performed at 310. At block 340 a time when at least one of the acts included in the behavioral pattern is detected is compared with a time stored in the storage 3 that is related to the stored at least one of the acts included in the behavioral pattern of the person. In the first path it is determined at block 360 whether the time when at least one of the acts included in the behavioral pattern is detected matches the time stored in the storage that is related to the at least one act included in the at least one behavioral pattern of the person stored in the storage. Depending on the result of the determination in block 360 it is determined that the access of the person to the defined space is allowed if the time when at least one of the acts included in the behavioral pattern is detected matches the stored time related to the at least one act included in the stored at least one behavioral pattern. If the time when at least one of the acts included in the behavioral pattern is detected does not match the stored time related to the at least one act included in the stored at least one behavioral pattern, it is determined that the access of the person to the defined space is not allowed.

Alternatively, or concurrently with the first path, the time when a personal characteristic is detected is detected at 320 in the second path. In block 350 the time when the personal characteristic is detected is compared with at least one time stored in the storage that is related to the stored at least one personal characteristic. In block 370 it is determined whether the time when the personal characteristic is detected matches the stored time related to the stored at least one personal characteristic. Depending on the result of the determination it is determined in block 380 that the access of the person to the defined space is allowed if it was determined that the time when the personal characteristic is detected matches the stored time or that the access of the person to the defined space is not allowed if it was determined that the time when the personal characteristic is detected does not match the stored time. In block 390 the result of one or both determination may be used in another method according to another aspect of the present application that is described with respect to FIG. 6.

In one or both of the first path or the second path it may be determined that the time when at least one of the acts included in the behavioral pattern or when a personal characteristic is detected matches the time stored in the storage 3 that is related to the at least one act included in the at least one behavioral pattern or the personal characteristic of the person as stored in the storage 3, when both times are separated by a time interval of less than 10, 1 hours, 60 minutes, 30 minutes, 10 minutes, 5 minutes, 1 minute, 30 seconds, 10 seconds, 1 second or less.

Another method according to another aspect of the application is shown in and described with regard to FIG. 6. The method includes receiving at 410 one or more results of determinations that the access of the person to the defined space is allowed or not from one or more of the methods described above with regard to FIGS. 3, 4, and 5 at 170, 260, and 390 and determining by combining one or more of the results that the access of the person to the defined space is allowed. For example, the access may be allowed if it was determined in at least one of the results that the access of the person to the defined space is allowed, and it may be determined that the access of the person to the defined space is not allowed if it was determined in at least one of the results that the access of the person to the defined space is not allowed.

Other criteria for deciding when the access of the person to the defined space is allowed or is not allowed in the combination of results can be applied in the method. For example, it may be determined that the access of the person to the defined space is allowed only if at least the result of the determination at 170, and at least one of the results of the determinations at 260 or 390 includes that the access of the person to the defined space is allowed. Another option would be that it is required that the results of all determinations at 170, 260 or 390 include that the access of the person to the defined space is allowed so that the access of the person to the defined space is allowed. Other decision criteria can be used as well. The decision criteria can be set be the user.

According to another aspect of the present disclosure, the results 170, 260, 390 of the determinations that the access of the person to the defined space is allowed or not as received from one or more of the previous methods can be weighted in order to include the weights in the combination result so that the different results of determination that the access of the person to the defined space is allowed or not may have more or less weight on the combination result than the other results.

The method may comprise generating a signal indicating that the access to the defined space by the person is allowed if it was determined that the access of the person to the defined space is allowed and to generating a signal triggering an alarm if it was determined that the access of the person to the defined space is not allowed.

The method may optionally comprise transmitting a signal including the result of the determination whether the access of the person to the defined space is allowed or is not allowed to a logic 17 for triggering an alarm in response to the result of the determination to a receiver for processing the result. At the receiver for example an alarm may be triggered or a security system is disarmed if the user is authorized to enter a defined space according to the result.

Furthermore, an alarm may be triggered directly in response to the result of the determination may be provided in the system as well.

According to yet another aspect of the present disclosure, a machine learning method may be provided to detect and learn at least one of one or more behavioral patterns and one or more characteristics of a person. The machine learning method may include a machine learning algorithm. The defined space can be an apartment, a house, an office, or a plant.

Aspects of the disclosed systems and methods may be implemented in a computing device and may include one or more bus-based interconnects between components and/or one or more point-to-point interconnects between components. Embodiments of the disclosed systems and methods may also be implemented as instructions stored on a tangible, machine-readable medium, which may be read and executed by one or more processors. A tangible, machine-readable medium may include any mechanism for storing or transmitting information in a form readable by a machine (e.g., a computing device). For example, a tangible, machine-readable medium may include read only memory (ROM), random access memory (RAM), magnetic disk storage, optical storage, flash memory, and/or other types of memory devices.

The computing device may be embodied as a personal computer, a workstation, a laptop computer, a handheld computer, a mobile internet device, a cellular phone, a personal data assistant, a telephony device, a network appliance, a virtualization device, a storage controller, or other computer-based device.

Aspects of the present disclosure may be implemented as any or a combination of: one or more microchips or integrated circuits interconnected using a motherboard, hardwired logic, software stored by a memory device and executed by a microprocessor, firmware, an application specific integrated circuit (ASIC), and/or a field programmable gate array (FPGA). The term “logic” may include, by way of example, software or hardware and/or combinations of software and hardware, and may refer to, be part of, or include an Application-Specific Integrated Circuit (ASIC), an electronic circuit, a processor (shared, dedicated, or group) and/or memory (shared, dedicated, or group) that execute one or more software or firmware programs, a combinational logic circuit, and/or other suitable components that provide the described functionality.

Aspects of the present disclosure may be provided, for example, as a computer program product which may include one or more machine-readable media having stored thereon machine-executable instructions that, when executed by one or more machines such as a computer, network of computers, or other electronic devices, may result in the one or more machines carrying out operations in accordance with aspects of the present disclosure.

A machine-readable medium may include, but is not limited to, floppy diskettes, optical disks, CD-ROMs (Compact Disc-Read Only Memories), and magneto-optical disks, ROMs (Read Only Memories), RAMs (Random Access Memories), EPROMs (Erasable Programmable Read Only Memories), EEPROMs (Electrically Erasable Programmable Read Only Memories), magnetic or optical cards, flash memory, or other type of media/machine-readable medium suitable for storing machine-executable instructions. The drawings and the forgoing description gave examples of different aspects of the present disclosure. Although depicted as a number of disparate functional items, those skilled in the art will appreciate that one or more of such elements may well be combined into single functional elements. Alternatively, certain elements may be split into multiple functional elements. Elements from one aspect of the present disclosure may be added to another aspect of the present disclosure. The scope of the aspects of the present disclosure, however, is by no means limited by these specific examples. Numerous variations, whether explicitly given in the specification or not, such as differences in structure, dimension, and use of material, are possible.

### Examples

The following examples pertain to further aspects of the present disclosure.

Example 1 is a monitoring system for monitoring access of a person to a defined space, comprising at least one sensor configured to detect a behavioral pattern of a person entering the defined space, a storage configured to store at least one behavioral pattern and at least one personal characteristic of the person, a pattern comparison logic configured to compare the detected behavioral pattern with the behavioral pattern stored in the storage, and determine that the access of the person to the defined space is allowed if at least the detected behavioral pattern matches the behavioral pattern stored in the storage as a result of the comparison or is not allowed if the detected behavioral pattern does not match the behavioral pattern stored in the storage as a result of the comparison, and logic configured to generate a signal indicating that the access to the defined space by the person is allowed if the pattern comparison logic determined that the access of the person to the defined space is allowed and to generate a signal triggering an alarm if the pattern comparison logic determined that the access of the person to the defined space is not allowed.

In example 2, the subject matter of example 1 can optionally include at least one further sensor configured to detect a personal characteristic of the person.

In example 3, the subject matter of example 2 can optionally include that the personal characteristic is a physical feature of the person, a feature of a device belonging to the person, a time when an act or a behavioral pattern is performed by the person.

In example 4, the subject matter of example 2 or 3 can optionally include that the at least one sensor is configured to detect a personal characteristic of the person is one of a camera, a RF receiver, an IR sensor, a PIR sensor, a touch pad, a fingerprint sensor, a mouse, a keyboard, and a biometric sensor.

In example 5, the subject matter of one of examples 1 to 4 can optionally further comprise a personal characteristic comparison logic configured to compare the detected personal characteristic with the personal characteristic stored in the storage, and determine that the access of the person to the defined space is allowed if at least the detected personal characteristic matches the personal characteristic stored in the storage as a result of the comparison or is not allowed if the detected personal characteristic does not match the personal characteristic stored in the storage as a result of the comparison.

In example 6, the subject matter of one of examples 1 to 5 can optionally include that the behavioral pattern of the person includes a sequence of one or more acts performed by the person including entering a location in the defined space, opening of a door of a room or a window in the defined space, entering a room in the defined space, actuating one of a switch, a light switch, a water tap, a remote control, an on-off switch of an household appliance, or an consumer electronics device.

In example 7, the subject matter of example 6 can optionally include that the pattern comparison logic determines that the detected behavioral pattern matches the behavioral pattern stored in the storage as a result of a comparison, when the sequence of acts of the detected behavioral pattern at least partly corresponds to the sequence of acts of the at least one behavioral pattern stored in the storage.

In example 8, the subject matter of example 7 can optionally include that the sequence of acts of the detected behavioral pattern at least partly corresponds to the sequence of acts of the at least one behavioral pattern stored in the storage when both sequences of acts include a same sequence of two or more subsequent acts.

In example 9, the subject matter of one of examples 6 to 8 can optionally further include that the system further comprises a time detection means for detecting a time when at least one of the acts included in the behavioral pattern is performed or the personal characteristic is detected, and a time comparison logic that is configured to compare at least one of the time when at least one of the acts included in the behavioral pattern is detected with a time stored in the storage that is related to the stored at least one of the acts included in the behavioral pattern of the person, and the time when the personal characteristic is detected with at least one time stored in the storage that is related to the stored at least one personal characteristic.

In example 10, the subject matter of example 9 can optionally include that the time comparison logic is further configured to determine that the access of the person to the defined space is allowed if at least one of the time when at least one of the acts included in the behavioral pattern is detected matches the time stored in the storage that is related to the at least one act included in the at least one behavioral pattern of the person stored in the storage or is not allowed if the time when the behavioral pattern is detected does not match the time stored in the storage that is related to the at least one act included in the at least one behavioral pattern of the person stored in the storage as a result of the comparison, and the time when the personal characteristic is detected matches the time stored in the storage that is related to the at least one personal characteristic of the person stored in the storage or is not allowed if the time when the personal characteristic is detected does not match the time stored in the storage that is related to the at least one personal characteristic of the person stored in the storage as a result of the comparison.

In example 11, the subject matter of example 9 or 10 can optionally include that the time comparison logic determines that the time when at least one of the acts included in the behavioral pattern is detected matches the time stored in the storage that is related to the at least one act included in the at least one behavioral pattern of the person stored in the storage, when both times are separated by a time interval of less than 60 minutes, 30 minutes, 10 minutes, 5 minutes, 1 minute, 30 seconds, 10 seconds, 1 second or less.

In example 12, the subject matter of one of examples 9 to 11 can optionally include that the system further comprises a combination logic that is configured to receive the results of the determinations that the access of the person to the defined space is allowed or not from one or more of the pattern comparison logic, the personal characteristic comparison logic, and the time comparison logic and determines that the access of the person to the defined space is allowed if at least one of the pattern comparison logic, the personal characteristic comparison logic, and the time comparison logic has determined that the access of the person to the defined space is allowed, and determines that the access of the person to the defined space is not allowed if at least one of the pattern comparison logic, the personal characteristic comparison logic, and the time comparison logic has determined that the access of the person to the defined space is not allowed.

In example 13, the subject matter of example 12 can optionally include that the combination logic is configured to weight the results of the determinations that the access of the person to the defined space is allowed or not from one or more of the pattern comparison logic, the personal characteristic comparison logic, and the time comparison logic.

In example 14, the subject matter of one of examples 1 to 13 can optionally include that the system further comprises a transmitter that is configured to transmit a signal including the result of the determination whether the access of the person to the defined space is allowed or is not allowed to a logic for triggering an alarm in response to the result of the determination.

In example 15, the subject matter of one of examples 1 to 14 can optionally include that the system comprises a machine learning logic configured to learn at least one of one or more behavioral patterns, one or more characteristics of a person, one or more times of detection of one or more behavioral patterns, and one or more characteristics of a person related therewith.

In example 16, the subject matter of one of examples 1 to 15 can optionally include that the defined space is an apartment, a house, an office, or a plant.

Example 17 is a method of monitoring access of a person to a defined space, comprising: detecting a behavioral pattern of a person entering the defined space; storing at least one behavioral pattern and at least one personal characteristic of the person in a storage; comparing the detected behavioral pattern with the behavioral pattern stored in the storage; determining that the access of the person to the defined space is allowed if at least the detected behavioral pattern matches the behavioral pattern stored in the storage as a result of the comparison or is not allowed if the detected behavioral pattern does not match the behavioral pattern stored in the storage as a result of the comparison; and generating a signal indicating that the access to the defined space by the person is allowed if it was determined that the access of the person to the defined space is allowed and to generating a signal triggering an alarm if it was determined that the access of the person to the defined space is not allowed.

In example 18, the subject matter of example 17 can optionally include detecting a personal characteristic of the person.

In example 19, the subject matter of examples 17 or 18 can optionally include comparing the detected personal characteristic with the personal characteristic stored in the storage; and determining that the access of the person to the defined space is allowed if at least the detected personal characteristic matches the personal characteristic stored in the storage s a result of the comparison or is not allowed if the detected personal characteristic does not match the personal characteristic stored in the storage as a result of the comparison.

In example 20, the subject matter of one of examples 17 to 19 can optionally include that the behavioral pattern of the person includes a sequence of one or more acts performed by the person including entering a location in the defined space, opening of a door of a room or a window in the defined space, entering a room in the defined space, actuating one of a switch, a light switch, a water tap, a remote control, an on-off switch of an household appliance, or an consumer electronics device.

In example 21, the subject matter of example 20 can optionally include it is determined that the detected behavioral pattern matches the behavioral pattern stored in the storage as a result of a comparison, when the sequence of acts of the detected behavioral pattern at least partly corresponds to the sequence of acts of the at least one behavioral pattern stored in the storage.

In example 22, the subject matter of example 21 can optionally include that the sequence of acts of the detected behavioral pattern at least partly corresponds to the sequence of acts of the at least one behavioral pattern stored in the storage when both sequences of acts include a same sequence of two or more subsequent acts.

In example 23, the subject matter of one of examples 20 to 22 can optionally include detecting a time when at least one of the acts included in the behavioral pattern is performed or the personal characteristic is detected, and comparing at least one of the time when at least one of the acts included in the behavioral pattern is detected with a time stored in the storage that is related to the stored at least one of the acts included in the behavioral pattern of the person, and the time when the personal characteristic is detected with at least one time stored in the storage that is related to the stored at least one personal characteristic.

In example 24, the subject matter of example 23 can optionally include determining that the access of the person to the defined space is allowed if at least one of the time when at least one of the acts included in the behavioral pattern is detected matches the time stored in the storage that is related to the at least one act included in the at least one behavioral pattern of the person stored in the storage or is not allowed if the time when the behavioral pattern is detected does not match the time stored in the storage that is related to the at least one act included in the at least one behavioral pattern of the person stored in the storage as a result of the comparison, and the time when the personal characteristic is detected matches the time stored in the storage that is related to the at least one personal characteristic of the person stored in the storage or is not allowed if the time when the personal characteristic is detected does not match the time stored in the storage that is related to the at least one personal characteristic of the person stored in the storage as a result of the comparison.

In example 25, the subject matter of example 23 or 24 can optionally include that it is determined that the time when at least one of the acts included in the behavioral pattern is detected matches the time stored in the storage that is related to the at least one act included in the at least one behavioral pattern of the person stored in the storage, when both times are separated by a time interval of less than 60 minutes, 30 minutes, 10 minutes, 5 minutes, 1 minute, 30 seconds, 10 seconds, 1 second or less.

In example 26, the subject matter of one of examples 17 to 25 can optionally include receiving one or more results of determinations that the access of the person to the defined space is allowed or not, and determining that the access of the person to the defined space is allowed if it was determined in at least one of the results that the access of the person to the defined space is allowed, and determining that the access of the person to the defined space is not allowed if it was determined in at least one of the results that the access of the person to the defined space is not allowed.

In example 27, the subject matter of example 26 can optionally include weighting one or more of the one or more results of determinations that the access of the person to the defined space is allowed or not.

In example 28, the subject matter of one of examples 17 to 27 can optionally include transmitting a signal including the result of the determination whether the access of the person to the defined space is allowed or is not allowed to a logic for triggering an alarm in response to the result of the determination.

In example 29, the subject matter of one of examples 23 to 28 can optionally include learning at least one of one or more behavioral patterns, one or more characteristics of a person, and one or more times of detection of one or more behavioral patterns and one or more characteristics of a person related therewith and storing the at least one of one or more behavioral patterns, one or more characteristics of a person and one or more times of detection of one or more behavioral patterns and one or more characteristics of a person related therewith as a part of the learning.

In example 30, the subject matter of one of examples 23 to 29 can optionally include updating at least one of one or more behavioral patterns, one or more characteristics of a person, and one or more times of detection of one or more behavioral patterns and one or more characteristics of a person related therewith stored in the storage 3 based on at least one of one or more detected behavioral patterns, one or more detected characteristics of a person, and one or more times of detection of one or more behavioral patterns and one or more characteristics of a person related therewith.

Example 31 is a computer readable medium comprising instructions stored thereon which when executed on a computer perform acts of monitoring access of a person to a defined space, comprising: detecting a behavioral pattern of a person entering the defined space; storing at least one behavioral pattern and at least one personal characteristic of the person in a storage; comparing the detected behavioral pattern with the behavioral pattern stored in the storage; determining that the access of the person to the defined space is allowed if at least the detected behavioral pattern matches the behavioral pattern stored in the storage as a result of the comparison or is not allowed if the detected behavioral pattern does not match the behavioral pattern stored in the storage as a result of the comparison, and generating a signal indicating that the access to the defined space by the person is allowed if it was determined that the access of the person to the defined space is allowed and to generating a signal triggering an alarm if it was determined that the access of the person to the defined space is not allowed.

In example 32, the subject matter of example 31 can optionally include instructions stored thereon which when executed on a computer perform an act of detecting a personal characteristic of the person.

In example 33, the subject matter of examples 31 or 32 can optionally include instructions stored thereon which when executed on a computer perform an act of comparing the detected personal characteristic with the personal characteristic stored in the storage; and determining that the access of the person to the defined space is allowed if at least the detected personal characteristic matches the personal characteristic stored in the storage result of the comparison or is not allowed if the detected personal characteristic does not match the personal characteristic stored in the storage as a result of the comparison.

In example 34, the subject matter of one of examples 31 to 33 can optionally include instructions stored thereon which when executed on a computer include that the behavioral pattern of the person includes a sequence of one or more acts performed by the person including entering a location in the defined space, opening of a door of a room or a window in the defined space, entering a room in the defined space, actuating one of a switch, a light switch, a water tap, a remote control, an on-off switch of an household appliance, or an consumer electronics device.

In example 35, the subject matter of example 34 can optionally include instructions stored thereon which when executed on a computer perform an act of determining that the detected behavioral pattern matches the behavioral pattern stored in the storage as a result of a comparison, when the sequence of acts of the detected behavioral pattern at least partly corresponds to the sequence of acts of the at least one behavioral pattern stored in the storage.

In example 36, the subject matter of example 35 can optionally include instructions stored thereon which when executed on a computer include that the sequence of acts of the detected behavioral pattern at least partly corresponds to the sequence of acts of the at least one behavioral pattern stored in the storage when both sequences of acts include a same sequence of two or more subsequent acts.

In example 37, the subject matter of one of examples 34 to 36 can optionally include instructions stored thereon which when executed on a computer perform acts of detecting a time when at least one of the acts included in the behavioral pattern is performed or the personal characteristic is detected, and comparing at least one of the time when at least one of the acts included in the behavioral pattern is detected with a time stored in the storage that is related to the stored at least one of the acts included in the behavioral pattern of the person, and the time when the personal characteristic is detected with at least one time stored in the storage that is related to the stored at least one personal characteristic.

In example 38, the subject matter of example 37 can optionally include instructions stored thereon which when executed on a computer perform the act of determining that the access of the person to the defined space is allowed if at least one of the time when at least one of the acts included in the behavioral pattern is detected matches the time stored in the storage that is related to the at least one act included in the at least one behavioral pattern of the person stored in the storage or is not allowed if the time when the behavioral pattern is detected does not match the time stored in the storage that is related to the at least one act included in the at least one behavioral pattern of the person stored in the storage as a result of the comparison, and the time when the personal characteristic is detected matches the time stored in the storage that is related to the at least one personal characteristic of the person stored in the storage or is not allowed if the time when the personal characteristic is detected does not match the time stored in the storage that is related to the at least one personal characteristic of the person stored in the storage as a result of the comparison.

In example 39, the subject matter of example 38 can optionally include instructions stored thereon which when executed on a computer include that it is determined that the time when at least one of the acts included in the behavioral pattern is detected matches the time stored in the storage that is related to the at least one act included in the at least one behavioral pattern of the person stored in the storage 3, when both times are separated by a time interval of less than 60 minutes, 30 minutes, 10 minutes, 5 minutes, 1 minute, 30 seconds, 10 seconds, 1 second or less.

In example 40, the subject matter of one of examples 31 to 39 can optionally include instructions stored thereon which when executed on a computer perform the act of receiving one or more results of determinations that the access of the person to the defined space is allowed or not, and determining that the access of the person to the defined space is allowed if it was determined in at least one of the results that the access of the person to the defined space is allowed, and determining that the access of the person to the defined space is not allowed if it was determined in at least one of the results that the access of the person to the defined space is not allowed.

In example 41, the subject matter of example 40 can optionally include instructions stored thereon which when executed on a computer perform the act of weighting one or more of the one or more results of determinations that the access of the person to the defined space is allowed or not.

In example 42, the subject matter of example 41 can optionally include instructions stored thereon which when executed on a computer perform the act of transmitting a signal including the result of the determination whether the access of the person to the defined space is allowed or is not allowed to a logic for triggering an alarm in response to the result of the determination.

In example 43, the subject matter of one of examples 37 to 42 can optionally include instructions stored thereon which when executed on a computer perform the act of learning at least one of one or more behavioral patterns, one or more characteristics of a person, and one or more times of detection of one or more behavioral patterns and one or more characteristics of a person related therewith and storing the at least one of one or more behavioral patterns, one or more characteristics of a person and one or more times of detection of one or more behavioral patterns and one or more characteristics of a person related therewith as a part of the learning.

In example 44, the subject matter of one of examples 37 to 43 can optionally include instructions stored thereon which when executed on a computer perform the act of updating at least one of one or more behavioral patterns, one or more characteristics of a person, and one or more times of detection of one or more behavioral patterns and one or more characteristics of a person related therewith stored in the storage (3) based on at least one of one or more detected behavioral patterns, one or more detected characteristics of a person, and one or more times of detection of one or more behavioral patterns and one or more characteristics of a person related therewith.

### REFERENCE NUMERALS

1 sensor for detecting behavioral pattern
3 storage
5 pattern comparison logic
7 Sensor for detecting personal characteristic
9 personal characteristic comparison logic
11 time detection means
13 time comparison logic
15 combination logic
17 transmitter
19 alarm triggering logic
21 machine learning logic

1-41. (canceled)

42. A monitoring system for monitoring access of a person to a defined space, comprising:
at least one sensor configured to detect a behavioral pattern of a person entering the defined space, the behavioral pattern including a sequence of one or more acts performed by the person;
a storage configured to store at least one behavioral pattern including a sequence of one or more acts related to the person and at least one personal characteristic of the person;
a pattern comparison logic configured to:
compare the detected behavioral pattern with the behavioral pattern stored in the storage; and
determine that the access of the person to the defined space is allowed if at least the detected behavioral pattern matches the behavioral pattern stored in the storage as a result of the comparison or is not allowed if the detected behavioral pattern does not match the behavioral pattern stored in the storage as a result of the comparison,
wherein the pattern comparison logic determines that the detected behavioral pattern matches the behavioral pattern stored in the storage, when the sequence of acts of the detected behavioral pattern performed by the person at least partly corresponds to the sequence of acts of the at least one behavioral pattern stored in the storage for the person; and
logic configured to generate a signal indicating that the access to the defined space by the person is allowed if the pattern comparison logic determined that the access of the person to the defined space is allowed and to generate a signal triggering an alarm if the pattern comparison logic determined that the access of the person to the defined space is not allowed.

43. The monitoring system of claim 42, wherein the system comprises at least one further sensor configured to detect a personal characteristic of the person.

44. The monitoring system of claim 43, further comprising a personal characteristic comparison logic configured to:
compare the detected personal characteristic with the personal characteristic stored in the storage; and
determine that the access of the person to the defined space is allowed if at least the detected personal characteristic matches the personal characteristic stored in the storage as a result of the comparison or is not allowed if the detected personal characteristic does not match the personal characteristic stored in the storage as a result of the comparison.

45. The monitoring system of claim 42, wherein the sequence of one or more acts performed by the person includes entering a location in the defined space, opening of a door of a room or a window in the defined space, entering a room in the defined space, actuating one of a switch, a light switch, a water tap, a remote control, an on-off switch of an household appliance, or an consumer electronics device.

46. The monitoring system of claim 42, wherein the sequence of acts of the detected behavioral pattern at least partly corresponds to the sequence of acts of the at least one behavioral pattern stored in the storage when both sequences of acts include a same sequence of two or more subsequent acts.

47. The monitoring system of claim 43, wherein the system further comprises
a time detection means for detecting a time when at least one of the acts included in the behavioral pattern is performed or the personal characteristic is detected, and
a time comparison logic that is configured to compare at least one of the time when at least one of the acts included in the behavioral pattern is detected with a time stored in the storage that is related to the stored at least one of the acts included in the behavioral pattern of the person, and the time when the personal characteristic is detected with at least one time stored in the storage that is related to the stored at least one personal characteristic.

48. The monitoring system of claim 47, wherein the time comparison logic is further configured to determine that the access of the person to the defined space is allowed if at least one of:
the time when at least one of the acts included in the behavioral pattern is detected matches the time stored in the storage that is related to the at least one act included in the at least one behavioral pattern of the person stored in the storage or is not allowed if the time when the behavioral pattern is detected does not match the time stored in the storage that is related to the at least one act included in the at least one behavioral pattern of the person stored in the storage as a result of the comparison, and
the time when the personal characteristic is detected matches the time stored in the storage that is related to the at least one personal characteristic of the person stored in the storage or is not allowed if the time when the personal characteristic is detected does not match the time stored in the storage that is related to the at least one personal characteristic of the person stored in the storage as a result of the comparison.

49. The monitoring system of claim 47, wherein the time comparison logic determines that the time when at least one of the acts included in the behavioral pattern is detected matches the time stored in the storage that is related to the at least one act included in the at least one behavioral pattern of the person stored in the storage, when both times are separated by a predetermined time interval.

50. The monitoring system of claim 47, wherein the system further comprises a combination logic that is configured to receive the results of the determinations that the access of the person to the defined space is allowed or not from one or more of the pattern comparison logic, the personal characteristic comparison logic, and the time comparison logic and determines that the access of the person to the defined space is allowed if at least one of the pattern comparison logic, the personal characteristic comparison logic, and the time comparison logic has determined that the access of the person to the defined space is allowed, and determines that the access of the person to the defined space is not allowed if at least one of the pattern comparison logic, the personal characteristic comparison logic, and the time comparison logic has determined that the access of the person to the defined space is not allowed.

51. The monitoring system of claim 50, wherein the combination logic is configured to weight the results of the determinations that the access of the person to the defined space is allowed or not from one or more of the pattern comparison logic, the personal characteristic comparison logic, and the time comparison logic.

52. The monitoring system of claim 42, wherein the system further comprises a transmitter that is configured to transmit a signal including the result of the determination whether the access of the person to the defined space is allowed or is not allowed to the logic for triggering an alarm in response to the result of the determination.

53. The monitoring system of claim 42, wherein the system comprises a machine learning logic configured to learn at least one of one or more behavioral patterns, one or more characteristics of a person, and one or more times of detection of one or more behavioral patterns and one or more characteristics of a person related therewith.

54. A method of monitoring access of a person to a defined space, comprising:
detecting a behavioral pattern of a person entering the defined space, the behavioral pattern including a sequence of one or more acts performed by the person;
storing at least one behavioral pattern including a sequence of one or more acts related to the person and at least one personal characteristic of the person in a storage;
comparing the detected behavioral pattern with the behavioral pattern stored in the storage;
determining that the access of the person to the defined space is allowed if at least the detected behavioral pattern matches the behavioral pattern stored in the storage as a result of the comparison or is not allowed if the detected behavioral pattern does not match the behavioral pattern stored in the storage as a result of the comparison, wherein it is determined that the detected behavioral pattern matches the behavioral pattern stored in the storage, when the sequence of acts of the detected behavioral pattern performed by the person at least partly corresponds to the sequence of acts of the at least one behavioral pattern stored in the storage for the person; and
generating a signal indicating that the access to the defined space by the person is allowed if it was determined that the access of the person to the defined space is allowed and to generating a signal triggering an alarm if it was determined that the access of the person to the defined space is not allowed.

55. The method of claim 54, further comprising:
detecting a personal characteristic of the person;
comparing the detected personal characteristic with the personal characteristic stored in the storage; and
determining that the access of the person to the defined space is allowed if at least the detected personal characteristic matches the personal characteristic stored in the storage as a result of the comparison or is not allowed if the detected personal characteristic does not match the personal characteristic stored in the storage as a result of the comparison.

56. The method of claim 54, wherein the sequence of acts of the detected behavioral pattern at least partly corresponds to the sequence of acts of the at least one behavioral pattern stored in the storage when both sequences of acts include a same sequence of two or more subsequent acts.

57. The method of claim 54, further comprising
detecting a time when at least one of the acts included in the behavioral pattern is performed or the personal characteristic is detected, and
comparing at least one of the time when at least one of the acts included in the behavioral pattern is detected with a time stored in the storage that is related to the stored at least one of the acts included in the behavioral pattern of the person, and the time when the personal characteristic is detected with at least one time stored in the storage that is related to the stored at least one personal characteristic.

58. The method of claim 57, further comprising determining that the access of the person to the defined space is allowed if at least one of:
the time when at least one of the acts included in the behavioral pattern is detected matches the time stored in the storage that is related to the at least one act included in the at least one behavioral pattern of the person stored in the storage or is not allowed if the time when the behavioral pattern is detected does not match the time stored in the storage that is related to the at least one act included in the at least one behavioral pattern of the person stored in the storage as a result of the comparison, and
the time when the personal characteristic is detected matches the time stored in the storage that is related to the at least one personal characteristic of the person stored in the storage or is not allowed if the time when the personal characteristic is detected does not match the time stored in the storage that is related to the at least one personal characteristic of the person stored in the storage as a result of the comparison.

59. The method of claim 54, further comprising receiving one or more results of determinations that the access of the person to the defined space is allowed or not, and determining that the access of the person to the defined space is allowed if it was determined in at least one of the results that the access of the person to the defined space is allowed, and determining that the access of the person to the defined space is not allowed if it was determined in at least one of the results that the access of the person to the defined space is not allowed.

60. The method of claim 57, further comprising learning at least one of one or more behavioral patterns, one or more characteristics of a person, and one or more times of detection of one or more behavioral patterns and one or more characteristics of a person related therewith and storing the at least one of one or more behavioral patterns, one or more characteristics of a person and one or more times of detection of one or more behavioral patterns and one or more characteristics of a person related therewith as a part of the learning.

61. The method of claim 57, further comprising updating at least one of one or more behavioral patterns, one or more characteristics of a person, and one or more times of detection of one or more behavioral patterns and one or more characteristics of a person related therewith stored in the storage based on at least one of one or more detected behavioral patterns, one or more detected characteristics of a person, and one or more times of detection of one or more behavioral patterns and one or more characteristics of a person related therewith.

62. A non-transitory computer readable medium comprising instructions stored thereon which when executed on a computer perform acts of monitoring access of a person to a defined space, comprising:
detecting a behavioral pattern of a person entering the defined space, the behavioral pattern including a sequence of one or more acts performed by the person;
storing at least one behavioral pattern and at least one personal characteristic of the person in a storage including a sequence of one or more acts related to the person;
comparing the detected behavioral pattern with the behavioral pattern stored in the storage;
determining that the access of the person to the defined space is allowed if at least the detected behavioral pattern matches the behavioral pattern stored in the storage as a result of the comparison or is not allowed if the detected behavioral pattern does not match the behavioral pattern stored in the storage as a result of the comparison, wherein it is determined that the detected behavioral pattern matches the behavioral pattern stored in the storage, when the sequence of acts of the detected behavioral pattern performed by the person at least partly corresponds to the sequence of acts of the at least one behavioral pattern stored in the storage for the person; and
generating a signal indicating that the access to the defined space by the person is allowed if it was determined that the access of the person to the defined space is allowed and to generating a signal triggering an alarm if it was determined that the access of the person to the defined space is not allowed.

63. The computer readable medium of claim 62, further comprising instructions stored thereon which when executed on a computer perform an act of:
detecting a personal characteristic of the person;
comparing the detected personal characteristic with the personal characteristic stored in the storage; and
determining that the access of the person to the defined space is allowed if at least the detected personal characteristic matches the personal characteristic stored in the storage as a result of the comparison or is not allowed if the detected personal characteristic does not match the personal characteristic stored in the storage as a result of the comparison.

64. The computer readable medium of claim 62, further comprising instructions stored thereon which when executed on a computer include that the sequence of acts of the detected behavioral pattern at least partly corresponds to the sequence of acts of the at least one behavioral pattern stored in the storage when both sequences of acts include a same sequence of two or more subsequent acts.

65. The computer readable medium of claim 62, further comprising instructions stored thereon which when executed on a computer perform acts of
detecting a time when at least one of the acts included in the behavioral pattern is performed or the personal characteristic is detected, and
comparing at least one of the time when at least one of the acts included in the behavioral pattern is detected with a time stored in the storage that is related to the stored at least one of the acts included in the behavioral pattern of the person, and the time when the personal characteristic is detected with at least one time stored in the storage that is related to the stored at least one personal characteristic.

66. The computer readable medium of claim 65, further comprising instructions stored thereon which when executed on a computer perform the act of determining that the access of the person to the defined space is allowed if at least one of:
the time when at least one of the acts included in the behavioral pattern is detected matches the time stored in the storage that is related to the at least one act included in the at least one behavioral pattern of the person stored in the storage or is not allowed if the time when the behavioral pattern is detected does not match the time stored in the storage that is related to the at least one act included in the at least one behavioral pattern of the person stored in the storage as a result of the comparison, and
the time when the personal characteristic is detected matches the time stored in the storage that is related to the at least one personal characteristic of the person stored in the storage or is not allowed if the time when the personal characteristic is detected does not match the time stored in the storage that is related to the at least one personal characteristic of the person stored in the storage as a result of the comparison.

67. The computer readable medium of claim 65, further comprising instructions stored thereon which when executed on a computer perform the act of learning at least one of one or more behavioral patterns, one or more characteristics of a person, and one or more times of detection of one or more behavioral patterns and one or more characteristics of a person related therewith and storing the at least one of one or more behavioral patterns, one or more characteristics of a person and one or more times of detection of one or more behavioral patterns and one or more characteristics of a person related therewith as a part of the learning.

68. The computer readable medium of claim 65, further comprising instructions stored thereon which when executed on a computer perform the act of updating at least one of one or more behavioral patterns, one or more characteristics of a person, and one or more times of detection of one or more behavioral patterns and one or more characteristics of a person related therewith stored in the storage based on at least one of one or more detected behavioral patterns, one or more detected characteristics of a person, and one or more times of detection of one or more behavioral patterns and one or more characteristics of a person related therewith.
